(19) United States
(12) Patent Application Publication
(10) Pub. No.: US 2014/0304116 A1
(43) Pub. Date: Oct. 9, 2014

(54) LIFE ADVISOR APPLICATION FOR TASK COMPLETION

(71) Applicants: Richard H Chan, Beijing (CN); Haoweng Huang, Beijing (CN)

(72) Inventors: Richard H Chan, Beijing (CN); Haoweng Huang, Beijing (CN)

(73) Assignee: MICROSOFT CORPORATION, Redmond, WA (US)

(21) Appl. No.: 13/395,631

(22) PCT Filed: Dec. 23, 2011
(86) PCT No.: PCT/CN2011/084515

§ 371 Date: Mar. 12, 2012

(51) Int. Cl. G06Q 30/06; G06F 3/0484; G06F 3/0481

(52) U.S. Cl. CPC G06Q 30/0625; G06F 3/04817; G06F 3/04842
USPC 705/26.62; 715/835

(57) ABSTRACT

A life advisor application may provide unified user interface pages for acquiring products or services that are used to accomplish multiple life activity tasks. The application may present user interface items for accessing the application. The user interface items may correspond to unified user interface pages for requesting product or service information that are aggregated from multiple data providers. Each unified user interface page may facilitate the accomplishment of a category of life activity tasks or a specific life activity task. When a selection of a user interface item is received, the application may be launched to receive a query for products or services that facilitates a life activity task associated with the selected user interface item.

### CROSS REFERENCE TO RELATED APPLICATIONS

This application is a 35 U.S.C. 371 National Stage application of International Application No. PCT/CN2011/084515, filed Dec. 23, 2011, the entire contents of which are incorporated herein by reference.

### BACKGROUND

Consumers generally spend a large portion of their disposable incomes on a few categories of products and services. Such categories may include dinning, clothing, travel, and entertainment. Consumers are also increasingly relying on their mobile devices to search for products and services in such categories. Merchants and their affiliated data providers who are attempting to provide information regarding such products and services may develop custom downloadable applications that consumers may install on their mobile devices. A consumer who has installed an application developed for a particular merchant may browse products or services provided by the particular merchant. However, when the consumer wants to browse products or services offered by another merchant, the consumer may be forced to download and install another application developed by the other merchant or a third-party data provider. Thus, a consumer may find that over time his or her mobile device is overloaded with multiple applications from many different merchants or data providers. This application overload may lead to consumer frustration or confusion when the consumer desires to use these applications.

### SUMMARY

Described herein are techniques for implementing a life advisor application that assists users in accomplishing multiple life activity tasks on a mobile device. The life activity tasks may include dinning out, buying clothing items, booking travel, booking hotels, making reservations, finding restaurants, among others. The life advisor application may be an application that is integrated natively with an operating system of a mobile device, or an application that is available for download and installation onto a mobile device. The mobile device may be a smart phone, a tablet computer, a personal digital assistant (PDA), or any other portable electronic device that interacts with a user via a user interface.

The life advisor application may interact with a life advisor engine that is on a server. The life advisor engine may provide the life advisor application with information on products and/or services that a user of the mobile device may wish to acquire in order to accomplish life activity tasks. In various embodiments, the life advisor engine may gather and aggregate the information from multiple data providers (e.g., merchant partners, deal aggregators, etc.). In turn, the life advisor application may provide unified user interface pages for a user of the mobile device to search for and acquire an item (e.g., a good or a service) regardless of the merchant that is providing the item or the nature of the item. In some embodiments, the search results provided by the life advisor engine and passed to the user via the life advisor application may be filtered according to user preferences and user context information.

In at least one embodiment, the life advisor application may present user interface items for accessing the application. The user interface items may correspond to unified user interface pages for requesting product or service information that are aggregated from multiple data providers. Each unified user interface page may facilitate accomplishment of a category of life activity tasks or a specific life activity task. When a selection of a user interface item is received, the application may be launched to receive a query for products or services that facilitates a life activity task associated with the selected user interface item.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements a life advisor application on multiple mobile devices.

FIG. 2 shows illustrative user interfaces for accessing the categories of functions offered by the life advisor application as installed on a mobile device.

FIG. 3 is an illustrative diagram that shows example components of the life advisor engine that facilitates life activity task fulfillment.

FIG. 4 is an illustrative diagram that shows example components of the mobile device that facilitates life activity task fulfillment.

FIG. 5 shows illustrative unified user interfaces that are displayed by the life advisor application for different products or services.

FIG. 6 is a flow diagram that illustrates an example process for launching the life advisor application to accomplish a particular life activity task selected from multiple life activity tasks.

FIG. 7 is a flow diagram that illustrates an example process for aggregating data on products or services from multiple data providers and providing filtered data via the life advisor application in response to a user query.

FIG. 8 is a flow diagram that illustrates an example process for collecting state data on a user via the mobile device for use by the life advisor engine.

FIG. 9 is a flow diagram that illustrates an example process for prompting a user to select an upgrade to access additional functions provided by the life advisor engine.

### DETAILED DESCRIPTION

The embodiments described herein pertain to techniques for implementing a life advisor application that assists users in accomplishing multiple life activity tasks on a mobile device. The life activity tasks may include dinning out, buying clothing items, booking travel, booking hotels, making reservations, finding restaurants, among other possible tasks. The life advisor application may be an application that is integrated natively with an operating system of a mobile device, or an application that is available for download and installation onto a mobile device. The mobile device may be a smart phone, a tablet computer, a personal digital assistant (PDA), or any other portable electronic device that interacts with a user via a user interface.

The life advisor application may interact with a life advisor engine that is hosted by a server. The life advisor engine may provide the life advisor application with information on products and/or services that a user of the mobile device may wish to acquire in order to accomplish life activity tasks. In various embodiments, the life advisor engine may gather and aggregate the information from multiple data providers (e.g., merchant partners, deal aggregators, etc). In turn, the life advisor application may provide unified user interface pages for a user of the mobile device to search for and acquire an item (e.g., a good or a service) regardless of the merchant that is providing the item or the nature of the item. The acquisition of an item by a user may include purchasing the item, leasing the item, renting the item, acquiring a license to use the item, or any other activity that enables the user to reserve the item, attain usage of the item, or attain possession of the item. In some embodiments, the search results provided by the life advisor engine and passed to the user via the life advisor application may be filtered according to user preferences and user context information.

The life advisor application may enable a user to obtain data from multiple merchants and/or data providers without downloading and installing multiple applications on the mobile device. Thus, the user may be spared the inconvenience of researching the function of many different applications, selecting a few desired applications from an often confusing array of applications to download from an application source, and downloading each of the desired applications onto the mobile device.

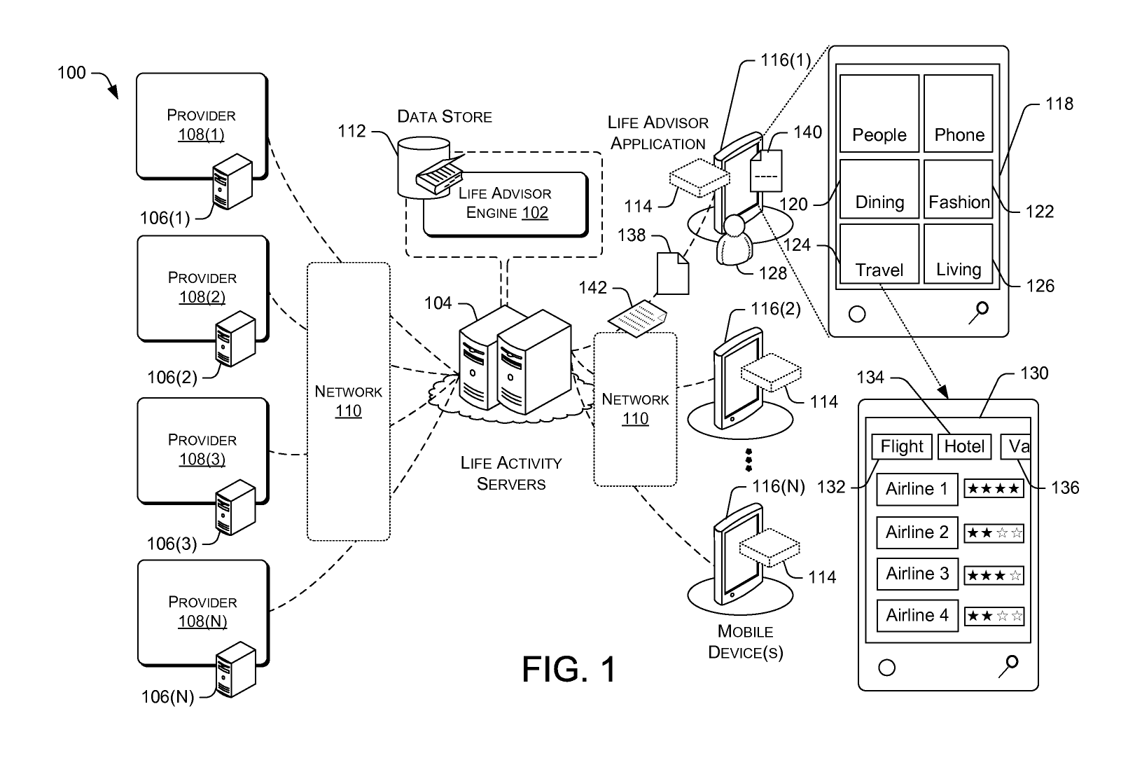

Further, the life advisor application may provide unified user interface pages regardless of the category of the life activity task to be accomplished or the types of the products or services the user desires to acquire. As a result, the life advisor application may relieve users the burden of learning to work with different application user interfaces and data formats. Thus, the users may focus their time on obtaining the information they want to accomplish life activity tasks rather than selecting and learning to interact with different applications. Various examples of techniques for implementing the life advisor application on mobile devices in accordance with various embodiments are described below with reference to FIGS. 1-9.

### Example Scheme

FIG. 1 is a block diagram that illustrates an example scheme 100 that implements a life advisor application on multiple mobile devices. In the example scheme 100, a life advisor engine 102 may be implemented by server(s) 104. The server(s) 104 may be part of a cloud computing service. In some embodiments, the server(s) 104 may reside in different data centers of the computing cloud. The life advisor engine 102 may obtain data from data servers 106(1)-106(N) of data providers 108(1)-108(N) via a network 110. The network 110 may be a local area network (“LAN”), a larger network such as a wide area network (“WAN”), and/or a collection of networks, such as the Internet. Protocols for network communication, such as TCP/IP, may be used to implement the network 110.

The data providers 108(1)-108(N) may include merchants that sell products or services, deal facilitators, and/or deal aggregators. For example, a merchant may be an airline that operates flights, a hotel that offers lodging, a restaurant that offers meals, or a clothing store that sells clothing items. A deal facilitator may be a deal broker that brings together merchants that offer particular products or services and customers who desire to acquire such products or services. Merchants may list their products or services with the deal facilitator at discounts to consumers in exchange for the ability of the deal facilitator to reach a wide consumer audience.

A deal aggregator may be an entity that collects information on products or services that are offered by the merchants. The deal aggregator may collect the information from the merchants on its own, or the merchants may submit information on the products or services in its inventory to the deal aggregator. In some embodiments, a deal facilitator or a deal aggregator may also provide a website that enables consumers to provide reviews on different merchants or reviews on the items offered by the merchants. The reviews may include comments, recommendations, and/or ratings. Each of the data providers 108(1)-108(N) may be partnered with an operator of the life advisor engine 102 to provide up-to-date information on products or services offered by the merchants to the life advisor engine 102. In turn, the life advisor engine 102 may store the collected information in a data store 112.

The life advisor engine 102 may interface with instances of a life advisor application 114 that is installed on each of mobile devices 116(1)-116(N) via the network 110. For example, an instance of the life advisor application 114 may be installed on the mobile device 116(1). Each of the mobile devices 116(1)-116(N) may be a smart phone, a tablet computer, a personal digital assistant (PDA), or any other portable electronic device that interacts with a user via a user interface.

The life advisor application 114 may provide a user interface 118 that enables a user of a mobile device, such as the mobile device 116(1), to access functions for accomplishing multiple categories of life activities tasks. In at least one embodiment, there be may be four categories of life activities tasks that are accessible via the user interface 118. The four categories may be “dining”, “travel”, “fashion”, and “living”. In such an embodiment, the “dinning” category may include life activity tasks such as finding a restaurant and making a restaurant reservation. The “travel” category may include life activity tasks such as booking flights, hotels, and/or vacations. The “fashion” category may include life activity tasks such as finding attractive clothing items and purchasing them. The “living” category may include life activity tasks such as finding apartments to rent, houses to purchase, or furnishings for homes.

Each of the categories may be accessible via a corresponding menu item on the user interface 118. For example, the “dinning” category may be accessible via a menu item 120, the “fashion” category may be accessible via a menu item 122, the “travel” category may be accessible via the menu item 124, and the “living” category may be accessible via the menu item 126. Accordingly, a user 128 of the mobile device 116(1) may select an appropriate menu item from the user interface 118 to accomplish a life activity task.

For example, when the user 128 desires to accomplish a life activity task that is in the “travel” category (e.g., book a flight), the user 128 may select the menu item 124 in the user interface 118. The selection of the menu item 124 may cause the life advisor application 114 to display the user interface page 130. The user interface page 130 may further include multiple subcategory menu items. For example, the user interface page 130 may include a subcategory menu item 132 that enables the user to book a flight, a subcategory menu item 134 that enables the user to book a hotel, or a subcategory menu item 136 that enables the user to book a complete vacation. Accordingly, once the user 128 of the mobile device 116(1) has navigated to the menu item 126, the user may further select a particular subcategory menu item (e.g., menu item 134) to accomplish a specific life activity task (e.g., book a flight).

In order to complete a life activity task, the user 128 of the mobile device 116(1) may submit a query 138 to the life advisor engine 102 via the life advisor application 114. For example, when the user 128 select the subcategory menu item 134 to book a flight, the life advisor application 114 may display a query interface page to the user 128. In turn, the user may use the query interface page to submit a query that includes information such as origin city, destination city, and date of travel, etc. The life advisor application 114 may pass the query information to the life advisor engine 102. In response, the life advisor engine 102 may retrieve the relevant information 140 that matches the query from the data store 112. In the example above, the relevant information 140 may include matching available flights.

The life advisor engine 102 may then return the relevant information 140 to the life advisor application 114 on the mobile device 116(1) for presentation to the user 128. In the example above, the user 128 may further select a flight and use the life advisor application 114 to transmit booking and payment information to the life advisor engine 102. In turn, the life advisor engine 102 may pass the booking and payment information to the corresponding merchant (e.g., airline) or a deal facilitator, such as the data provider 108(1), for processing to complete the acquisition transaction.

In some embodiments, the life advisor engine 102 may tailor the relevant information that is returned to a user based on the state of the user. For example, the life advisor application 102 may tailor the relevant information 140 returned to the instance of the life advisor application 114 on the mobile device 116(1) based on state data of the user 128. The state data of a user may include user preference data and user context data. The user preference data may indicate user preference for specific merchants or specific types of merchants. The user context data may include data related to the user, such as a user's geographical location obtained from global positioning system (GPS) data, an address corresponding to the user's geographical location, time zone and time at the user's location, the weather at the user's location, and/or events occurring at the user's location, among other data. In this way, the life advisor engine 102 may receive the state data on users from the instances of the life advisor application 114 that are running on different mobile devices, such as the mobile devices 116(1)-116(N).

For example, the state data 142 returned to the life advisor engine 102 by the mobile device 116(1) may indicate that the user 128 of the mobile device 116(1) prefers airlines that are rated three stars or higher when booking a flight. The state data may further indicate that the current time at the user's location is 1:00 p.m., and the user is currently located an hour by vehicle travel from the airport in the origin city. Accordingly, the life advisor engine 102 may further filter the relevant information 140 (e.g., available flights that are retrieved from the data store 112) based on the state data 142 prior to sending the relevant information 140 to the mobile device 116(1). For example, the life advisor engine 102 may eliminate from the relevant information 140 any flight that departs within an hour of the current time and/or flights operated by airlines without adequate ratings. Alternatively or concurrently, the life advisor engine 102 may also append additional information to the relevant information 140, such as a map and/or directions that indicate a route from the user's current location to the airport in the origin city, for delivery to the life advisor application 114 on the mobile device 116(1).

In other embodiments, in addition to facilitating the retrieval of data from the data providers 108(1)-108(N), the combination of the life advisor application 114 and the life advisor engine 102 may enable users of the mobile device 116(1)-116(N) to upload review information, such as comments, ratings, and/or recommendations back to the data providers 108(1)-108(N). The review information may be for products, services, and/or merchants that provided the products or the services. In turn, the review information may be displayed by the data providers 108(1)-108(N) on corresponding websites.

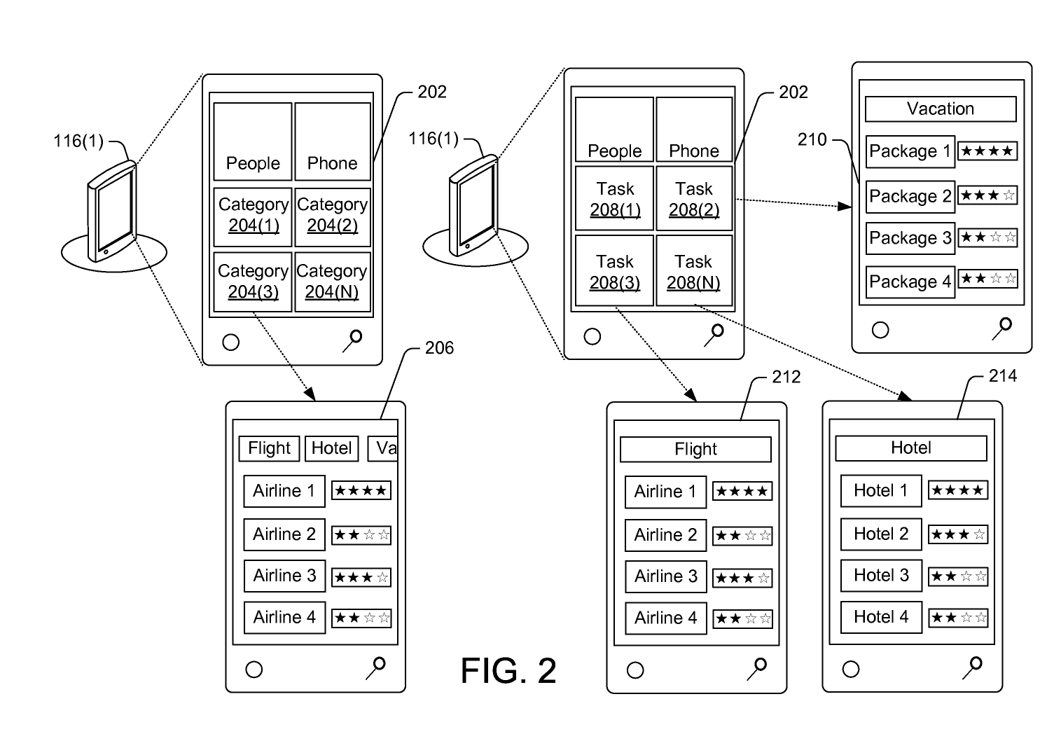

FIG. 2 shows illustrative user interfaces for accessing the categories of functions offered by the life advisor application 114. As described above, a user interface for interacting with the life advisor application 114 may include menu items for accessing functions that facilitate categories of life activity tasks. For example, as shown in FIG. 2, a user interface menu 202 that is displayed on the mobile device 116(1) may include menu items 204(1)-204(N). Each of the menu items may correspond to functions for performing a specific category of life activity tasks. For example, the menu item 204(3) may correspond to functions for performing life activity tasks in a “travel” category. Accordingly, a selection of the menu item 204(3) may bring up a user interface menu 206 that enables a user to complete travel-related tasks, such as booking a flight, booking a hotel, and/or booking a vacation. In various embodiments, the user interface menu 202 may be a top-level root user interface menu of the life advisor application 114 that is displayed when the user powers on a mobile device, such as the mobile device 116(1).

However, in alternative embodiments, the user interface menu 202 may be customized to present menu items 208(1)-208(N), in which each menu item activates a function that performs a specific life activity task. Each of the specific life activity tasks may be a task in the categories of life activity tasks. For example, a selection of the menu item 208(2) may activate a user interface menu 210 that enables the user to book a vacation. A selection of the menu item 208(3) may activate a user interface menu 212 that enables the user to book a flight, and a selection of the menu item 208(4) may activate a user interface menu 214 that enables the user to book a hotel.

Accordingly, in various instances, the user interface menu 202 of the life advisor application 114 may be customized to show the menu items described above via a setup menu. The customization may cause the user interface menu 202 to display menu items that correspond to functions that facilitate categories or life activity tasks, or display menu items in which each menu item corresponds to a particular function for a specific life activity task. However, in other instances, a user may customize the user interface menu 202 to simultaneously display a combination of at least one menu item that corresponds to functions for performing a category of life activity tasks, as well as at least one menu item that corresponds to the function for performing a specific life activity task.

In additional embodiments, the user may also customize the menu items that are displayed by the life advisor application 114 according to categories of life activity tasks and/or life activity task subcategories that are of interest to the user. Thus, the customization may include deletion and/or addition of one or more menu items to the user interface menu 202. For example, the user may customize the user interface menu 202 to not display a menu item that corresponds to functions for the “fashion” category. Alternatively or concurrently, the user may customize the user interface menu 202 to display another menu item that corresponds to functions for an “entertainment” category of life activity tasks. The functions for the “entertainment” category may include functions that enable the purchasing of tickets for movies, sporting events, shows, etc. In various embodiments, the life advisor application 114 may provide a set up menu that enables such customization.

### Life Advisor Engine Components

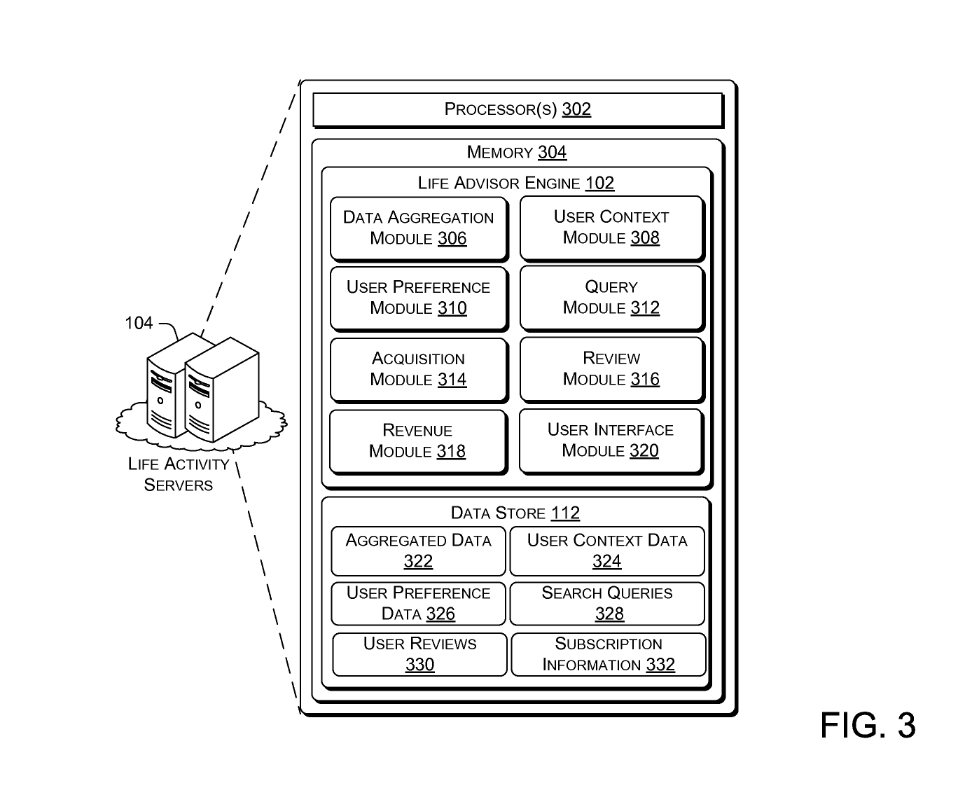

FIG. 3 is an illustrative diagram that shows example components of the life advisor engine 102 that facilitates life activity task fulfillment. The life advisor engine 102 may be implemented by the server(s) 104. The server(s) 104 may includes one or more processors 302, memory 304, and/or user controls that enable a user to interact with the electronic device. The memory 304 may be implemented using computer readable media, such as computer storage media. Computer-readable media includes, at least, two types of computer-readable media, namely computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media. The server(s) 104 may have network capabilities. For example, the server(s) 104 may exchange data with other electronic devices (e.g., laptops computers, servers, etc.) via one or more networks, such as the Internet.

The life advisor engine 102 may include may include a data aggregation module 306, a user context module 308, a user preference module 310, a query module 312, an acquisition module 314, a review module 316, a revenue module 318, and a user interface module 320. The memory 304 may also implement a data store 112.

The data aggregation module 306 may collect data on products and services that are offered by the merchants from the data providers 108(1)-108(N). The data providers 108(1)-108(N) may include merchants that sell the products or services, deal facilitators, and/or deal aggregators. The data may be information on the products or services, such as the cost of an item, the quantities of the item that are available for acquisition, descriptions of the item, sale or lease terms, and/or other details that may assist a user to determine whether to acquire the item. In various embodiments, the data may be collected based on partnership agreements between an operator of the life advisor engine 102 and the data providers 108(1)-108(N). The acquisition of an item by a user may include purchasing the item, leasing the item, renting the item, acquiring a license to use the item, or any other activity that enables the user to reserve the item, attain usage of the item, or attain possession of the item. In various embodiments, the data providers 108(1)-108(N) may provide up-to-date data to the life advisor engine 102 on a continuously basis or a periodic basis. In some embodiments, the data providers 108(1)-108(N) may also include web mapping service data providers, public transportation information data providers (e.g., transit authorities), weather data providers, emergency news sources, and/or so forth. The collected data may also include information associated with the products or services, such as consumer and professional reviews, comments, ratings, and/or recommendations. The data aggregation module 306 may store the collected data in the data store 112.

The data aggregation module 306 may further classify the collected data according to categories of life activity tasks prior to storing the data in the data store 112. Such categories may include “dining”, “travel”, “fashion”, and “living”. For example, data collected from a merchant that is an airline concerning available flights may be placed in the “travel” category, while data collected from a merchant that is a restaurant concerning open bookings may be placed in the “dinning” category. Likewise, data collected from apartments with vacancies may be placed in the “living” category, while data collected from an online merchant that sells clothing items may be placed in the “fashion” category. The sorting of the collected data by the data aggregation module 306 may facilitate expedient retrieval of data to match user queries. Alternatively or concurrently, the data aggregation module 306 may also classify the collected data according to subcategories of the categories. For example, data collected from an airline may be placed in a “flight” subcategory in addition or instead of being placed in the “travel” category. The data aggregation module 306 may organize the collected data by tagging each piece of data from a merchant with corresponding category and/or subcategory metadata.

In various embodiments, the data aggregation module 306 may use one or more machine learning or classification algorithms to classify each piece of collected into one of the categories and/or subcategories. The machine learning algorithms may include supervised learning algorithms, unsupervised learning algorithms, semi-supervised learning algorithms, and/or so forth. The classification algorithms may include support vector machines, neural networks, expert systems, Bayesian belief networks, fuzzy logic, data fusion engine, and/or so forth. In other embodiments, the data aggregation module 306 may employ one or more of directed and undirected model classification approaches, such as naïve Bayes, Bayesian networks, decision trees, neural networks, fuzzy logic models, and/or other probabilistic classification models.

The user context module 308 may collect context data on each user that is using a life advisor application 114 on a corresponding mobile device of the mobile devices 116(1)-116(N). For example, the life advisor application 114 installed on the mobile device 116(1) may collect context information on the user 128. The life advisor application 114 may then report the collected context information to the user context module 308. In turn, the user context module 308 may store the context data for each user in the data store 112. The context data collected by the user context module 308 on each user may include the geographical location of the user, whether the geographical location corresponds to a known address associated with the user (e.g., home, work, school, etc). In some embodiments, the user context module 308 may obtain the geographical location of a user from a GPS functionality of a corresponding mobile device.

The context data collected for a user may further include other data, such as the time and time zone of the user, the weather, traffic conditions around the vicinity of the geographical location of the user, a schedule or appointments of the user, and/or so forth. Such context data associated with the user may be collected from one or more applications on the corresponding mobile device (e.g., a weather application, a traffic application, a calendar application, etc.).

In various embodiments, the user context module 308 may be configured to collect the context data related to a user after obtaining permission from the user. For example, prior to collecting context data on the user 128, the user context module 308 may cause the life advisor application 114 installed on the mobile device 116(1) to display a dialog box. The dialog box may indicate to the user 128 that personal information is to be collected from the user 128. The dialog box may identify the type and each source of information to be collected. In this way, the user 128 may be given the opportunity to opt out of the context data collection performed by the user context module 308. In some embodiments, after the user 128 consents, the user context module 308 may display one or more other dialog boxes that further enable the user 128 to select the specific types of context information that the user context module 308 may collect. For example, the user 128 may allow the user context module 308 to collect location data on the user 128, but not appointment data from a calendar application installed on a mobile device 116(1). In this way, each users who is using the life advisor application 114 may have the ability to safeguard his or her personal data.

The user preference module 310 may collect user preferences of each user that is using an instance of the life advisor application 114 on a corresponding mobile device. For example, the user 128 may indicate certain preferences to the life advisor application 114 that is installed on the mobile device 116(1). In various instances, the user 128 may indicate preferences for one or more merchants (e.g., one or more favorite airlines), and/or one or more merchants that the user 128 desire to exclude as product or service suppliers. In some instances, the user 128 may also indicate one or more criteria that a merchant is to meet in order to be considered by the user 128. For example, the user 128 may indicate that a preference for airlines that are rated three stars or higher when booking a flight, a restaurant that is within a predetermined proximity of a current geographical location of the user 128 when booking a restaurant, and/or so forth.

The query module 312 may receive queries from the instances of the life advisor application 114 that are installed on the mobile devices 116(1)-116(N). Each query may seek to acquire a product or a service from the merchants included in the data providers 108(1)-108(N). For example, the mobile device 116(1) may send a request from the user 128 to the query module 312 indicating that the user 128 desires to book a flight from Seattle to Beijing on a particular date.

In turn, the query module 312 may perform a search of the product or service data stored in the data store 112 according to a received query to find matching data. Once the query module 312 has located information on products or services that match the query, the relevant information may be returned by the query module 312 to a corresponding mobile device that initiated the query for display to a user. For example, in the example above, the query module 312 may return information on flights offered by one or more airlines that match the query of the user 128 to the life advisor application 114 that is on the mobile device 116(1). The life advisor application 114 on the mobile device 116(1) may then display the flight information to the user 128.

In some embodiments, the query module 312 may modify the matching data to be returned to a user of a mobile device based on the user state and/or preferences of the user. The user state of the user may be collected by the user context module 308, and the user preferences may be collected by the user preference module 310. The modification may include filtering of the matching data based on the user preferences of a user. For example, information on flights returned to the user 128 may be filtered to exclude flights on airlines that failed to attain at least a three star rating on a five star scale, or leave out flights on airlines that are specifically excluded by the user 128. Alternatively or concurrently, the modification may include supplementing the matching data with additional information that may help the user to complete a life activity task. For example, the query module 312 may return the matching information on flights along with a hyperlink to a web page that shows a map and/or directions to the departure airport from a current location of the user 128. In some instances, the directions may further include contact information of taxi companies or directions for taking public transportation to the departure airport.

The acquisition module 314 may enable users of the life advisor application 114 to acquire products or services described in the data returned by the query module 312. As described above, the acquisition of an item by a user may include purchasing the item, leasing the item, renting the item, acquiring a license to use the item, or any other activity that enables the user to reserve the item, attain usage of the item, or attain possession of the item. For example, the user 128 may indicate a desire to book a flight that matches a query using a user interface option of the life advisor application 114 that is installed on the mobile device 116(1). In turn, the life advisor application 114 on the mobile device 116(1) may display a user interface page that prompts the user to provide personal information (e.g., identity of the user, contact information of the user, residential and billing address of the user, etc). The user interface page may also prompt the user to enter payment information (e.g., credit card number, bank account number, etc). Once the user has supplied the requested information, the life advisor application 114 may pass the supplied information to the acquisition module 314. The acquisition module 314 may in turn pass on the supplied information to the corresponding merchant to complete the acquisition transaction.

The review module 316 may enable users of the life advisor application 114 to provide reviews on different merchants and/or the items offered by the merchants. Each of the reviews may include comments, recommendations, and/or ratings. For example, the user 128 may use a user interface page supplied by the life advisor application 114 on the mobile device 116(1) to select a merchant, a product, or a service for review. After the user 128 has selected the entity to review, the life advisor application 114 may provide another user interface page that enables the user 128 to input the appropriate review, comments, recommendations, and/or ratings for the selected entity. In turn, the life advisor application 114 may pass the review to the review module 316. The review module 316 may store the review in the data store 112. In some instances, the review module 316 may provide a web page that displays the reviews to users. Alternatively or concurrently, each of the reviews may be passed by the review module 316 to one or more relevant parties, e.g., a merchant, a deal aggregator, and/or a deal facilitator. Each of the relevant parties may elect to display the reviews received from the review module 316 of the life advisor engine 102.

The revenue module 318 may collect fees from the merchants for facilitating the acquisitions of products or services from the merchants. In some embodiments, the revenue module 318 may collect a portion of the profit from the merchants for each item acquired through the acquisition module 314. In such embodiments, the acquisition module 314 may send details regarding a completed acquisition to the revenue module 318. In turn, the revenue module 318 may collect a fixed fee and/or a portion of merchant profit from the acquisition for facilitating the acquisition. In other instances, the merchants may request to offer discounts or promotions for products or services through the life advisor engine 102 to users of the life advisor application 114. In such instances, the revenue module 318 may be configured to charge a merchant a flat free, pay-per-impression fee, and/or pay-per-click fee for displaying each discount or promotion to users through instances of the life advisor application 114 that are installed on the mobile devices 116(1)-116(N). In still other instances, the merchants may request to place advertisements on the user interface pages that are displayed by the instances of the life advisor application 114 on the mobile devices 116(1)-116(N). For example, the advertisements may be placed on query pages or query result pages that are displayed by each instance of the life advisor application 114. In such instances, the revenue module 318 may charge each of the merchants a periodically recurring display fee or a per impression fee for displaying such advertisements. In some embodiments, the amount of fee for displaying each advertisement may be calculated according to the display position and/or prominence of the advertisement on a user interface page.

In other embodiments, the revenue module 318 may collect subscription fees from the users of the life advisor application 114. In such embodiments, the services offered by the life advisor engine 102 may be divided into service levels, in which each higher level offers additional service. For example, a first free subscription level may enable users of the life advisor application 114 on the mobile device 116(1)-116(N) to search for products or services for completing their life activity tasks. However, if a user desires to acquire products or services, the revenue module 318 may prompt the user to upgrade to a higher paid service subscription level that permits such activity. Moreover, if the user further desires to access customized services, such as filtering of product or services returned in response to a query and/or access special discounts, the revenue module 318 may prompt the user to upgrade to an even higher paid service subscription level.

Thus, in such embodiments, the revenue module 318 may track the service subscription level paid for by a user of a life advisor application 114 that is installed on a mobile device. Accordingly, the revenue module 318 may work cooperatively with the query module 312 and the acquisition module 314 to return customized information that conform to the paid subscription level to the life advisor application 114 on the mobile device in response to a query. For example, the customized information may include query results, item prices, offer details, and/or so forth. In some instances, the revenue module 318 may prompt the user to upgrade to a higher service subscription level when the user indicates to the life advisor application 114 a desire to perform an action that is only available with the higher service subscription level. Further, depending on whether the user selects the upgrade option, the revenue module 318 may authorize or terminate the action.

For example, when a user who is currently using the free subscription level indicates a desire to book a flight that is returned as a part of a travel service query, the revenue module 318 may cause the life advisor application 114 to prompt the user to upgrade to a higher paid service subscription level. The upgrade prompt may be displayed via a dialog box or a user interface page. Any payments for the upgrade may be processed by the acquisition module 314. Further, depending on whether the user selects the upgrade option, the revenue module 318 may either permit the user to book the flight or deny the flight booking request.

The user interface module 320 may enable the user to interact with the modules of the life advisor engine 102 using a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In some embodiments, the user interface module 320 may enable an administrator to configure the other modules of the life advisor engine 102. For example, but not as limitations, the administrator may use the user interface module 320 to edit the aggregated data stored in the data store 112, create, delete or modify user preferences, service subscription levels and/or context information of the users, review payments received, view submitted reviews, and/or so forth.

The data store 112 may store the information that are collected or processed by the modules of the life advisor engine 102. Such information may include aggregated data 322 gathered by the data aggregation module 306, user context data 324 gathered by the user context module 308, and user preference data 326 gathered by the user preference module 310. Additionally, the information may further include search queries 328 submitted to the query module 312, acquisition information submitted to the acquisition module 314, and user reviews 330 submitted to the review module 316. The information may also include service subscription information 332 on the users of the life advisor application 114, and/or other data, such as GPS data.

### Mobile Device Components

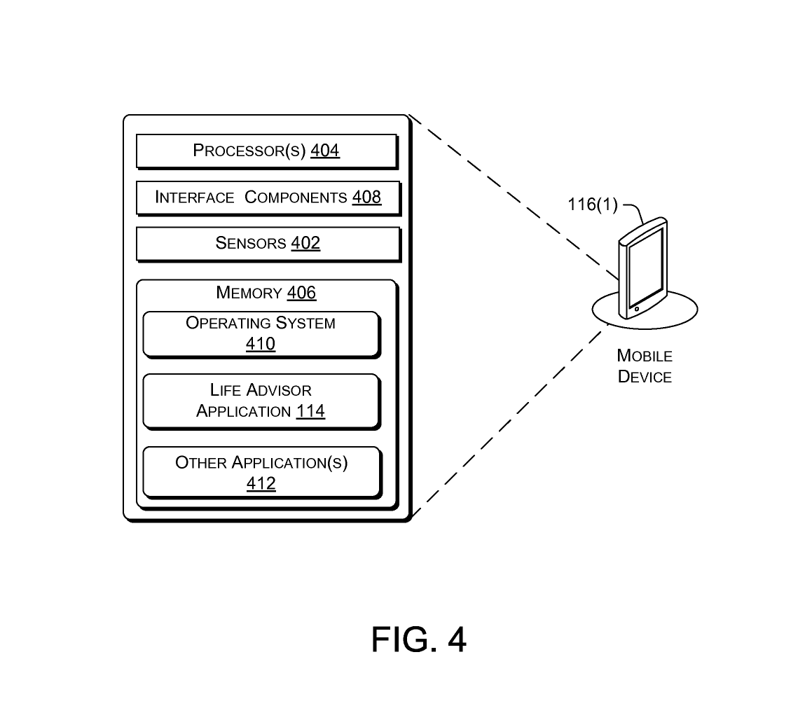

FIG. 4 is an illustrative diagram that shows example components of a mobile device. As described above, an instance of the life advisor application 114 that communicates with the life advisor engine 102 may be installed on a mobile device. A mobile device, such as the mobile device 116(1), may be any mobile electronic device that is capable of acquiring text, image, video and audio data using input interfaces (e.g., camera, keyboard, touch display, microphone, and/or the like), process such data, and output the processed data via output interfaces (e.g., displays, screens, speakers, and/or the like). The mobile device 116(1) may include sensors 402 that acquire other information. The sensors 402 may include a location sensor, such as a global position system (GPS) sensor and/or a network-assisted GPS sensor. The sensors 402 may also include a compass direction sensor, a motion sensor, an inertia sensor, and/or the like.

The mobile device 116(1) may further include one or more processors 404, memory 406, as well as interface components 408. The interface components 408 may include wireless and/or wired communication interface components that enable the mobile device 116(1) to transmit and receive data via the network 110. The interface components 408 may also include user interface components. The user interface component may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

The memory 406 may store an operating system 410. The operating system 410 may include components that enable the mobile device 116(1) to receive data via various inputs (e.g., user controls, network interfaces, and/or memory devices), and process the data using the one or more processors 404 to generate output. The operating system 410 may include one or more components that present the output (e.g., display an image on an electronic display, store data in memory, transmit data to another electronic device, etc.). Additionally, the operating system 410 may include other components that perform other functions generally associated with an operating system.

The memory 406 may further store the life advisor application 114. The life advisor application 114 may include components that support the collection of user context data 324, the user preference data 326, and the user reviews 238 from a user of the life advisor application 114. For example, the life advisor application 114 may include components that render user interface pages and menus that prompt and receive such information. As described above, the life advisor application 114 may further render user interface pages and menus that assist the user in completing life activity tasks. For example, the life advisor application 114 may receive queries for products and services that are offered by the merchants, pass on such queries to the life advisor engine 102, and return data on available products and services from the merchants. In some instances, the life advisor application 114 may also prompt the user to subscribe to different service levels under the guidance of the life advisor engine 102. In various embodiments, the functions of the life advisor application 114 that enables a user to complete life activity tasks may be accessible via the user interface menus that are described with respect to FIGS. 1, 2, and 5.

In at least one embodiment, one or more other applications 412 may be stored in the memory 226. The one or more applications 412 may perform various functions, depending on the nature of the mobile device 116(1). For example, when the mobile device 116(1) is a mobile phone, the one or more applications 412 may include software that facilitates the placement of voice calls, sending of text, or browsing of the web using a communication network. In another example in which the mobile device 116(1) is a tablet computing, the other applications 412 may be office productivity applications. Other examples applications that may be included in the applications 412 may include a calendar/appointment application, a game application, a media player application, a weather status application, and/or so forth.

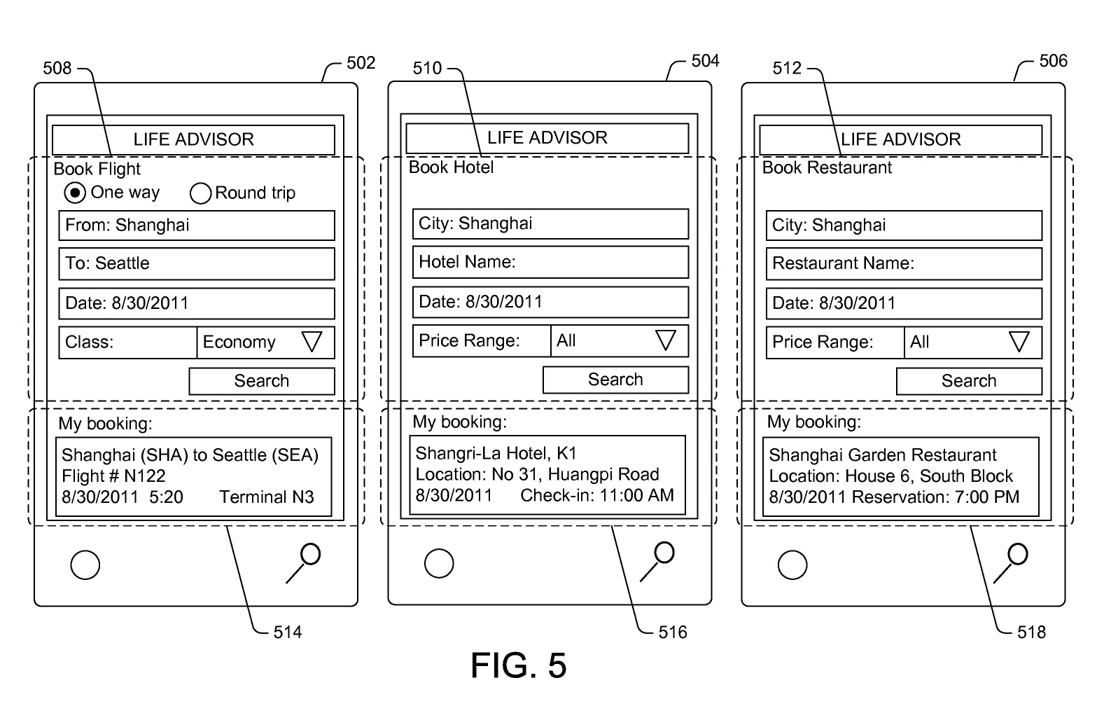

FIG. 5 shows illustrative unified user interfaces that are displayed by the life advisor application for different products or services. As described above, the life advisor application 114 may provide unified user interface pages for a user of a mobile device, such as the mobile device 116(1), to enable acquisition of items regardless of the merchants that are providing the items or the nature of the items. In this way, a user of the life advisor application 114 may enjoy consistent user interaction experiences even when purchasing items from different merchants to complete life activity tasks. For example, the life advisor application 114 may display user interface pages 502-506 to the user of the mobile device 116(1). Each of the user interface pages 502-506 may assist in a user in completing a life activity task. For example, the user interface page 502 may enable the user to book a flight, the user interface page 504 may enable the user to book a hotel, and the user interface page 506 may enable the user to book a reservation at a restaurant. As shown in FIG. 5, each of the user interface pages 502-506 may have similar user interface elements. For instance, the user interface pages 502-506 may include similar search sections 508-512, respectively, that enable the user to look for suitable services that the user desires to acquire. The user interface pages 502-506 may also include similar booking sections 514-518, respectively, that show the services that are booked by the user. In various embodiments, the user interface pages that are similar in appearance, as provided by the life advisor application 114, may include user interface pages for accomplishing other life activity tasks. These other user interface pages may facilitate searching for an apartment, buying clothing items, buying tickets for entertainment events (e.g., movies, sporting events), and/or so forth. Moreover, the user interface pages provided by the life advisor application 114 may also include additional common user interface elements other than the sections 508-512 or sections 514-518, respectively. As such, the user interface pages 502-506 are merely examples rather than limitations.

Accordingly, by providing unified user interface pages, i.e., user interface pages that are similar in appearance for disparate items to be acquired, the life advisor application 114 may relieve users from the burden of learning to work with different application user interfaces and data formats. Thus, the users may focus their time on obtaining the information they want to accomplish life activity tasks rather than selecting and learning to interact with different applications.

### Example Processes

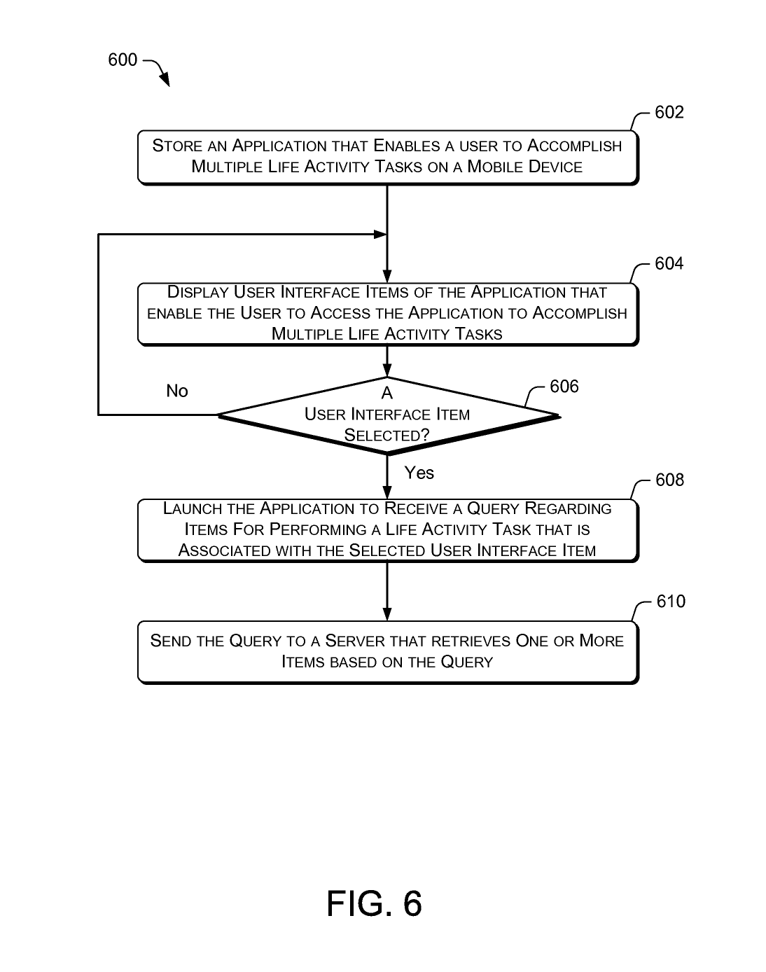

FIGS. 6-9 describe various example processes for implementing a life advisor application that assists users in accomplishing multiple life activity tasks on a mobile device. The order in which the operations are described in each example process is not intended to be construed as a limitation, and any number of the described operations can be combined in any order and/or in parallel to implement each process. Moreover, the operations in each of the FIGS. 6-9 may be implemented in hardware, software, and a combination thereof. In the context of software, the operations represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 6 is a flow diagram that illustrates an example process 600 for launching the life advisor application 114 to accomplish a particular life activity task selected from multiple life activity tasks.

At block 602, the life advisor application 114 may be stored on a mobile device, such as the mobile device 116(1) that is used by a user (e.g., the user 128). In other words, the life advisor application 114 may be installed on the mobile device 116(1). The life advisor application 114 may provide functions that enable the user 128 to accomplish multiple life activity tasks. For example, the life activity tasks may include tasks such as booking a flight, booking a hotel, making a reservation at a restaurant, purchasing a cloth item, and/or so forth.

At block 604, the life advisor application 114 may display user interface items on a display of the mobile device 116(1). The user interface items may provide access to functions provided by the life advisor application 114. Each of the user interface items may enable access to functions for accomplish a category of life activity tasks, or enable access to a particular function for accomplishing a specific life acidity task.

At decision block 606, the life advisor application 114 may determine whether a user interface item from among the user interface items is selected. If no user interface item is selected (“no” at decision block 606), the process 600 may loop back to block 604 so that the user interface items may be further displayed. However, if a user interface item from among the user interface items is selected (“yes” at decision block 606), the process 600 may proceed to block 608.

At block 608, the life advisor application 114 may be launched to show a user interface page that corresponds to the one or more life activity tasks associated with the selected user interface item. For example, if the user selected a “travel” user interface item, the life advisor application 114 may be launched to show a user interface page for booking travel-related services, such as flights, hotels, etc. The user interface page may enable the user 128 to submit a query for products or services that may assist the user in accomplishing a life activity task. In turn, the life advisor application 114 may receive the query and pass the query to the life advisor engine 102.

At block 610, the life advisor application 114 may send the query to a server that retrieves one or more items based on the query. In various embodiments, each of the one or more items may be a product or service that matches the query. Each product or service may assist the user 128 with accomplishing the life activity task that is associated with the selected user interface item.

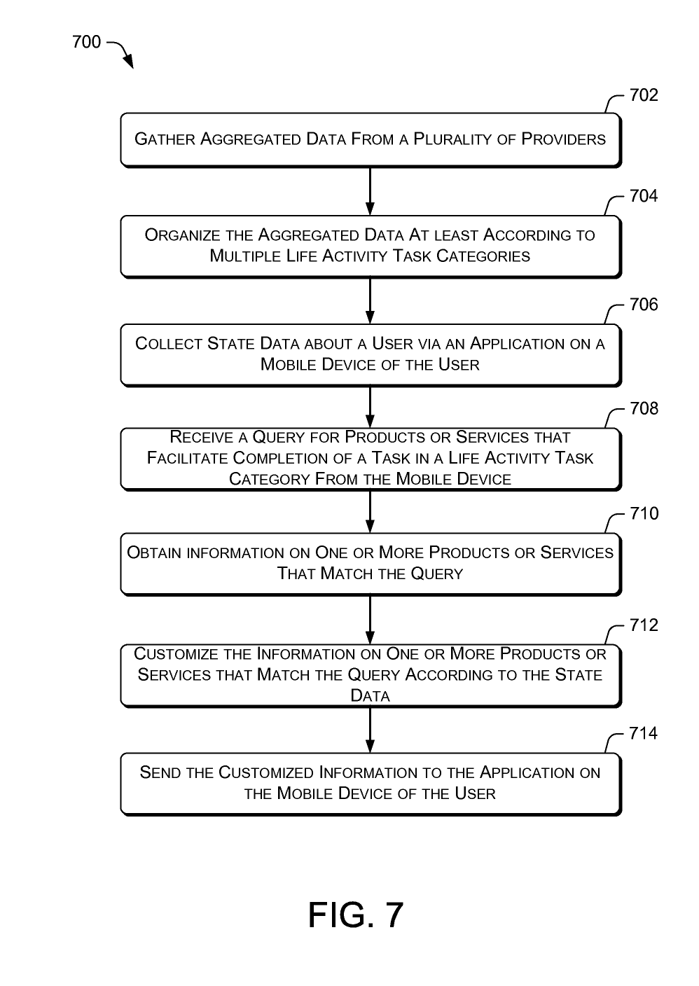

FIG. 7 is a flow diagram that illustrates an example process 700 for aggregating data on products and services from multiple data providers and providing modified data via the life advisor application 114 in response to a user query.

At block 702, the life advisor engine 102 may receive data from a plurality of data providers 108(1)-108(N). In various embodiments, the life advisor engine 102 may use the data aggregation module 306 to aggregate the data from the data providers. The data providers 108(1)-108(N) may include merchants, deal aggregators, and/or deal facilitators. The data may include details on products and/or services that are offered by the merchants. The products or services may enable users to accomplish life activity tasks.

At block 704, the data aggregation module 306 of the life advisor engine may organize the data at least according to multiple life activity task categories. Such categories may include “dining”, “travel”, “fashion”, and “living”. Alternatively or concurrently, the data aggregation module 306 may also classify the collected data to correlate with the specific life activity tasks in the categories. The sorting of the collected data by the data aggregation module 306 may facilitate expedient retrieval of data that match a user query. In various embodiments, the data aggregation module 306 may organize the collected data by tagging each piece of data from a merchant with corresponding category and/or task metadata.

At block 706, the life advisor engine 102 may collect state data about a user (e.g., the user 128) that is using a life advisor application 114 on a mobile device, such as the mobile device 116(1). In various embodiments, the life advisor application 114 may detect and pass the state data regarding the user to the life advisor engine 102. The state data of the user 128 may include context data and/or preference data. The context data may be collected by the user context module 308 and the preference data may be collected by the user preference module 310.

At block 708, the query module 312 may receive the query 138 for products or services that facilitate completion of a task in a life activity category from the mobile device 116(1) of the user 128. The user 128 may have formulated the query 138 by indicating a life activity task to complete using a user interface menu displayed by the life advisor application 114 on the mobile device 116(1), and then inputting query details via a corresponding user interface page furnished by the life advisor application 114. For example, the query details may be itinerary information on a flight that the user 128 desires to take.

At block 710, the query module 312 may obtain information on one or more products or services that matches the query from a data store 112 of the life advisor engine 102. Each product or service offered may assist the user 128 in completing a life activity task. In various embodiments, the query module 312 may use the category and/or task metadata of each product or service in the data store 112 to search for the one or more matching products or services.

At block 712, the query module 312 may further customize the matching data according to the state data of the user 128. The customization may include filtering out at least one product or service based on the preferences or the context data of the user 128. Alternatively or concurrently, the customization may include supplementing the matching data with additional information (e.g., maps, directions, etc.) that may help the user to complete a life activity task.

At block 714, the query module 312 may send the customized data to the life advisor application 114 on the mobile device 116(1) of the user 128. The customized data may be displayed to the user 128 by the life advisor application 114.

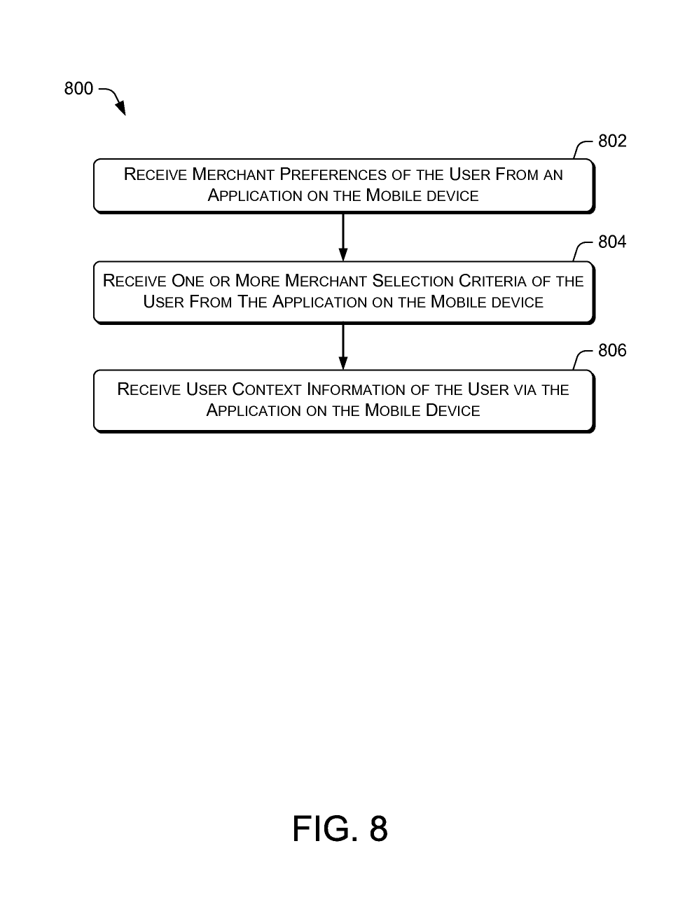

FIG. 8 is a flow diagram that illustrates an example process 800 for collecting state data on a user via the mobile device for use by the life advisor engine. The example process 800 may further illustrate block 706 of the process 700.

At block 802, the user preference module 310 may receive merchant preferences of a user (e.g., the user 128) from a life advisor application 114 that is installed on a mobile device, such as the mobile device 116(1). In some instances, the merchant preferences may reflect that the user does not wish to receive product or service offers from one or more merchants. In other instances, the merchant preferences may indicate that the user desires to view product or service offers from one or more merchants first, or view the product or service offers according to a specific priority list assigned to at least some of the merchants.

At block 804, the user preference module 310 may receive one or more merchant selection criteria of the user 128 from the life advisor application 114 on the mobile device 116(1). Each of the selection criteria may be a requirement that a merchant is to meet in order for the user 128 to consider products or services offered by the merchant. For example, the user 128 may indicate that a preference for airlines that are rated three stars or higher when booking a flight, a restaurant that is within a predetermined proximity of a current geographical location of the user 128 when booking a restaurant, and/or so forth.

At block 806, the user context module 308 may continuously receive user context information of the user 128 from the life advisor application 114 on the mobile device 116(1). For example, the user context data may include data related to the user, such as a user's geographical location, time zone and time at the user's geographical location, the weather at the user's location, events occurring at the user's location, appointments of the user, and/or so forth. In various embodiments, the life advisor application 114 may obtain such context data on the user from one or more other applications on the mobile device 116(1).

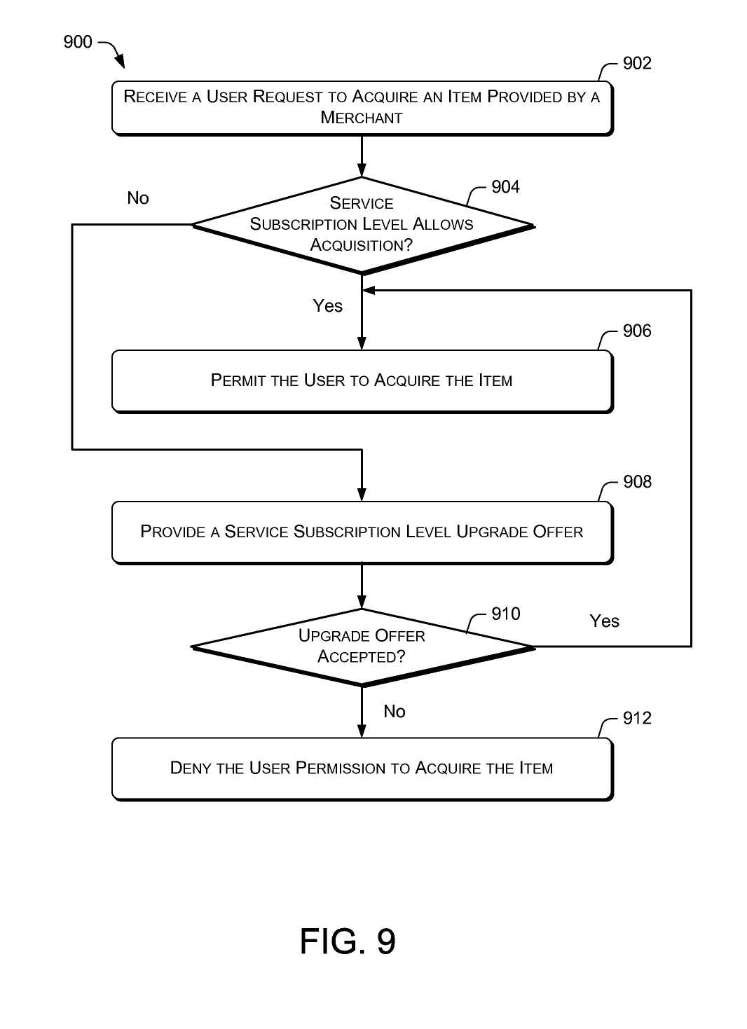

FIG. 9 is a flow diagram that illustrates an example process 900 for prompting a user 128 to select an upgrade to access additional functions provided by the life advisor engine 102.

At block 902, the acquisition module 314 on the life advisor engine 102 may receive a request from a user (e.g., the user 128) to acquire an item provided by a merchant. The request may be received from the life advisor application 114 that is installed on a mobile device, such as the mobile device 116(1). The user may make the request after viewing information on products or services that are returned by the life advisor engine 102 to the life advisor application 114 on the mobile device 116(1) in response to a query from the user.

At decision block 904, a revenue module 318 may determine whether a service subscription level of the user allows the user to acquire the item. In various embodiments, a free service subscription level may enable the user to query for information on goods or services offered by merchants, while a paid subscription level may enable the user to further acquire the item. The acquisition of an item by a user may include purchasing the item, leasing the item, renting the item, acquiring a license to use the item, or any other activity that enables the user to reserve the item, attain usage of the item, or attain possession of the item. Accordingly, if the revenue module 318 determines that the service subscription level of the user allows the acquisition (“yes” at decision block 904), the process 900 may proceed to block 906.

At block 906, the revenue module 318 may authorize the acquisition module 314 to receive payment and/or booking from the user so that the user may acquire the item from the merchant. In various embodiments, the acquisition module 314 may pass any payment received from the user to the corresponding merchant to complete an acquisition transaction for the item.

However, if the revenue module 318 determines that the serviced subscription level of the user does not allow the acquisition (“no” at decision block 904), the process 900 may proceed to block 908.

At block 908, the revenue module 318 may provide a service subscription level upgrade offer to the user 128. The offer may include information such as benefits of the upgrade, fees for the upgrade, terms of the offers, and/or other relevant information related to the upgrade. The revenue module 318 may pass the offer to the life advisor application 114 on the mobile device 116(1) for displayed to the user 128.

At decision block 910, the revenue module 318 may determine whether the user 128 accepted the upgrade offer. In various embodiments, the user 128 may accept the upgrade offer by making an upgrade fee payment to the revenue module 318 via a payment user interface page. The payment user interface page may be provided to the user 128 by the life advisor application 114 on the mobile device 116(1). Accordingly, if the revenue module 318 determines that the user 128 has accepted the upgrade offer (“yes” at decision block 910), the process 900 may loop back to block 906, so that revenue module 318 may authorize the acquisition module 314 to receive payment and/or booking from the user, such that the user may acquire the item from the merchant.

However, if the revenue module 318 determines that the user 128 has not accepted the upgrade offer (“no” at decision block 910), the process 900 may proceed to block 912. At block 912, the revenue module 318 may deny the user 128 permission to acquire the item. It will be appreciated that while the upgrade offer is discussed in the process 900 in the context of being permitted to acquire an item, the life advisor engine 102 may also provide offers to upgrade to a service subscription for other benefits in a similar manner. These other benefits may include exclusive discounts from merchants, the modification of query results according to user state data, exclusive offers from merchants, and/or so forth.

A life advisor application installed on a mobile device, in conjunction with the life advisor engine on a server, may provide a user of a mobile device with unified user interface pages for acquiring products or services. The products or services may assist the user in accomplishing different life activity tasks. The unified user interface pages may be consistent in appearance regardless of the category of the life activity task to be accomplished, the types of the products or services, or the suppliers of the products or services. Accordingly, the life advisor application may relieve users the burden of learning to work with different application user interfaces and data formats. Thus, users may focus their time on obtaining the information they want to accomplish life activity tasks rather than selecting and learning to interact with different applications.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

What is claimed is:

1. A computer-implemented method, comprising:
storing an application that enables a user to accomplish multiple life activity tasks in a mobile device;
presenting user interface items for accessing the application on a display of the mobile device, the user interface items providing access to unified user interface pages for requesting product or service information that are aggregated from multiple data providers, each unified user interface page facilitating accomplishment of a category of life activity task or a specific life activity task;
receiving a selection of a user interface item presented on the display on the mobile device; and
launching the application to receive a query using a corresponding unified user interface page in response to the selection of the user interface item, the query being for products or services that facilitates a life activity task associated with the user interface item.

2. The computer-implemented method of claim 1, further comprising:
sending the query to a server that retrieves relevant information on at least one item that matches the query, each item being a product or a service;
receiving the relevant information at the mobile device; and
presenting the relevant information on the display of the mobile device.

3. The computer-implemented method of claim 2, further comprising:
receiving a request from the user to acquire an item described in the relevant information, the request including a payment for the item; and
passing the request to a server that processes acquisition requests; and
indicating that a transaction to acquire the item is completed on the display of the mobile device after the server indicates acceptance of the payment; and
indicating that the request is denied on the display of the mobile device after the server disapproves the request.

4. The computer-implemented method of claim 2, wherein the relevant information is filtered according to at least one of context information or a preference of the user.

5. The computer-implemented method of claim 2, wherein the relevant information is modified to include a link to at least one of a map or a set of directions that show a location of the user in relation to a source of an item to assist the user in acquiring or using the item.

6. The computer-implemented method of claim 1, wherein the unified user interface pages include user interface pages for performing life activity tasks in a travel category, a dinning category, a fashion category, and a living category.

7. A computer-readable medium storing computer-executable instructions that, when executed, cause one or more processors to perform acts comprising:
gathering aggregated data about products or services offered by merchants from a plurality of data providers;
organizing the aggregated data according to at least one of multiple life activity task categories or life activity tasks in the multiple life activity categories;
collecting state data of a user, the state data received from an application on a mobile device of the user;
receiving a query for at least one item that facilitates completion of a life activity task in a life activity task category from the mobile device, each item being a product or a service;
obtaining relevant information on one or more items that match the query using organized aggregated data; and
customizing the relevant information according to the state data to generate customized information.

8. The computer-readable medium of claim 7, further comprising sending the customized information to the application on the mobile device for display to the user.

9. The computer-readable medium of claim 7, further comprising:
receiving a request of the user to acquire an item described in the customized information, the request including a payment for the item;
approving the request to acquire the item when a service subscription level of the user permits the request; and
denying the request to acquire the item when the service subscription level of the user does not permit the request.

10. The computer-readable medium of claim 9, further comprising passing the payment to a merchant to complete an acquisition of the item by the user when the request is approved.

11. The computer-readable medium of claim 9, further comprising sending an service subscription level upgrade offer for the user to the application on the mobile device when the service subscription of the user does not permit the request.

12. The computer-readable medium of claim 7, further comprising sending user feedback regarding a product or a service that is received from the application on the mobile device to a corresponding merchant.

13. The computer-readable medium of claim 7, wherein the state data includes at least one of a merchant preference of the user, a merchant selection criterion of the user, or context information associated with the user.

14. The computer-readable medium of claim 13, wherein the context information includes at least one of a geographical location of the user, a time zone and time at the geographical location of the user, weather information at the geographical location of the user, events occurring at the geographical location of the user, or appointments of the user.

15. The computer-readable medium of claim 7, wherein the customizing includes at least one of filtering out details on an item offered by a merchant from the relevant information or modifying the relevant information to include additional instructions based at least on the state data.

16. The computer-readable medium of claim 7, wherein customizing includes offering a discount on at least one item described in the relevant information as provided by a service subscription level of the user.

17. A system, comprising:
one or more processors; and
a memory that includes a plurality of computer-executable components executable by the one or more processors, the plurality of computer-executable components comprising:
a data aggregation component that obtains aggregated data on products or services offered by merchants from a plurality of data providers and organizes the aggregated data according to at least one of multiple life activity task categories or life activity tasks in the multiple life activity categories;
a user context component that collects context information about a user through an application on a mobile device of the user; and
a query component that receives a query for at least one item that facilitates completion of a life activity task in a life activity task category from the mobile device, in which each item is a product or a service, and customizes relevant information on one or more items that match the query according to the context information.

18. The computing device of claim 17, further comprising a user preference component that collects a user preference of the user through the application on the mobile device, wherein the query component customizes the relevant information according to the context information and the user preference.

19. The computing device of claim 17, wherein the query component further sends the relevant information that is customized to the application on the mobile device for display to the user.

20. The computing device of claim 17, further comprising at least one of:
an acquisition component that facilitates an acquisition of an item offered by a merchant by the user by receiving a payment of the user on behalf of the merchant and sending the payment to the merchant;
a review component that sends a received user feedback regarding the item to the merchant; and
a revenue component that receives a fee from the merchant for at least one of sending an advertisement of the merchant to the application on the mobile device for display on a user interface page or facilitating the acquisition of the item offered by the merchant by the user.
